(19) United States
(12) Patent Application Publication
(10) Pub. No.: US 2010/0219169 A1
(43) Pub. Date: Sep. 2, 2010

(54) METHOD AND DEVICE FOR PRODUCING NOZZLE-TYPE OPENINGS IN SPRAY ARMS FOR DISHWASHER MACHINES

(75) Inventors: Bernd Heisele, Sontheim (DE); Claus Köther, Niederstotzingen (DE); Karlheinz Rehm, Dischingen Ortst. Trugenhofen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munich (DE)

(21) Appl. No.: 12/779,139

(22) Filed: May 13, 2010

Related U.S. Application Data
(63) Continuation of application No. 10/525,713, filed on Aug. 29, 2005, now abandoned.

(30) Foreign Application Priority Data
Aug. 22, 2002 (DE) 10238557.2

(51) Int. Cl. B23K 26/38

(52) U.S. Cl. 219/121.71; 219/121.7; 219/121.82

(57) ABSTRACT

A device and a method for producing nozzle-type openings in spray arms for dishwasher machines, which enables the form of the nozzle-type openings in spray arms to alter rapidly even if only one spray arm is provided and enable different nozzle geometries to be created during the production process in the event of different spray arms.

### CROSS REFERENCE TO RELATED APPLICATIONS

This application is a continuation, under 35 U.S.C. §120, of U.S. application Ser. No. 10/525,713, filed Aug. 29, 2005, which was a U.S. national stage application, under 35 U.S.C. §371, of International Application No. PCT/EP2003/009246, filed Aug. 20, 2003, which designated the United States; this application also claims the priority, under 35 U.S.C. §119, of German patent application No. 102 38 557.2, filed Aug. 22, 2002; the prior applications are herewith incorporated by reference in their entirety.

### BACKGROUND OF THE INVENTION

The invention relates to a method and device for producing nozzle-type openings in spray arms for dishwasher machines.

In known methods and devices for producing nozzle-type openings in spray arms for dishwasher machines the spray arms comprised of plastic are produced by means of a so-called extrusion blowing procedure, i.e. a granulate or pulverulent plastic is plasticised in a thermal method and this highly viscous mass is then put into a corresponding form by a moulding tool. Because the spray arms are designed hollow, a hose produced according to the abovedescribed extrusion process is utilised as starting body for producing the spray arms, which is heated to a certain temperature and in this deformable state is pressed by a corresponding blowing procedure into a cooled profile tool. The resulting spray arm blank exhibits all the features of the finished spray arm, including the recessed nozzle-type openings, which must be produced in a second manufacturing step.

Because the nozzle-type openings are openings, it is currently not possible to produce the nozzle-type openings during the extrusion blowing procedure. For this the regions of the spray arm blank, provided for the nozzle-type openings, are designed as so-called domes, which must be removed or respectively processed in a further manufacturing process.

In conventional terms the spray arm blanks for producing the nozzle-type openings are subjected to a cutting or machining process, whereby the nozzle-type openings are made by means of cutters or milling heads, i.e. finger millers and/or spiral borers, for example in that the projecting domes are excised or milled off.

Conventional methods method for producing nozzle-type openings in spray arms are therefore cost-intensive and require subsequent processing devices in which the spray arm blanks must be clamped, which undergo a certain wear and subsequently maintenance.

It has also proven disadvantageous that variations of the nozzle-type openings in the spray arms make refitting the reworking devices necessary, since in particular each form of the nozzle-type openings is of decisive importance also as the angle of the nozzle duct for operation of the spray arm, though refitting and adapting the reworking devices is time-intensive, mechanically demanding and cost-intensive. An additional outcome is time and cost-intensive expenditure for test runs of the devices and mould production of the spray arms.

### BRIEF SUMMARY OF THE INVENTION

The object of the present invention is therefore to provide a device and a method for producing nozzle-type openings in spray arms for dishwasher machines, which enables the form of the nozzle-type openings in spray arms to alter rapidly even if only one spray arm is provided and enable different nozzle geometries to be created during the production process in the event of different spray arms.

With the inventive method for producing nozzle-type openings in spray arms for dishwasher machines nozzle-type openings of differing shape are cut out by laser from the surface of the spray arm blank after the spray arm blank has been produced.

With the inventive use of laser it can be guided such during this excising of the nozzle-type openings that the walls of the nozzle duct are designed such that there are desired, and not unnecessary, turbulence of the emerging spray stream in the vicinity of the nozzle exit, i.e. the flow behaviour of the spray stream can be adjusted by corresponding use of the behaviour of the spray stream by corresponding use of the laser. Because the nozzle-type openings are sharp-edged e.g. this can create constriction of the discharge stream, determined by the discharge quantity u. The result of this discharge quantity u is an increase in the nozzle cross-section surface, by which blockages or contamination of the nozzle-type openings are prevented.

The openings can advantageously have different forms, which deviate from a circular form, such as for example ellipsoid, corrugated, rectangular, rhombic etc.

In a preferred variant of the inventive method the laser for excising the nozzle-type openings can be shifted and pivoted slightly in its position, so that not only can the form of the nozzle ducts be designed variously, but also the nozzle duct as such can have different angles of inclination.

The inventive device for carrying out a method for producing nozzle-type openings has a device for fixing the spray arm blank and a correspondingly positionable laser, arranged on the fixing device such that the surface of the spray arm blank can be fitted with nozzle-type openings.

The advantage of the inventive device is that the laser used to cut out the nozzle-type openings is configured to vary slightly in its position to the surface of the spray arm, so that different patterns for the arrangement of the openings can be made after short set-up times or respectively reprogramming times.

It is of particular advantage here that no mounting of the laser is to undergo any mechanical force and thus a device can be selected, which is cost-effective to produce.

What is claimed is:

1. A method for producing a spray arm having a nozzle with nozzle-type openings for dishwasher machines, the method comprising:
removing, via laser, material from a spray arm blank to form a nozzle;
removing, via laser, material from a wall of a duct of the nozzle to form a predetermined flow behavior of a discharge stream from the nozzle; and
removing, via laser, material on a surface of the nozzle so as to form the nozzle-type openings.

2. The method for producing a spray arm according to claim 1, wherein the nozzle-type openings are formed by the laser into one or more shapes that cause constriction of the discharge stream.

3. The method for producing a spray arm according to claim 2, wherein the one or more shapes comprise circular, ellipsoid, corrugated, rectangular, and rhombic shapes.

4. The method for producing a spray arm according to claim 1, wherein the nozzle-type openings are sharp-edged.

5. The method for producing a spray arm according to claim 1, wherein the predetermined flow behavior of the discharge stream from the nozzle is a turbulent flow behavior at an exit of the nozzle.

6. A device for producing a spray arm having a nozzle with nozzle-type openings for dishwasher machines, the device comprising:
a device for releasably securing a spray arm blank; and
a laser disposed relative to the device for releasably securing the spray arm blank, the laser being structured to remove material from a spray arm blank to form a nozzle, remove material from a wall of a duct of the nozzle to form a predetermined flow behavior of a discharge stream from the nozzle, and remove material on a surface of the nozzle so as to form the nozzle-type openings.

7. The device for producing a spray arm according to claim 6, wherein at least one of the device for releasably securing a spray arm blank and the laser is structured to at least one of shift and pivot such that the removal of the material on the surface of the nozzle so as to form the nozzle-type openings can be performed by the laser at varying angles of inclination.
